(19) United States
(12) Patent Application Publication
(10) Pub. No.: US 2008/0167793 A1
(43) Pub. Date: Jul. 10, 2008

(54) APPARATUS FOR FILTERING MEASURED ANALOG SIGNAL USED TO CONTROL VEHICLE ENGINE

(75) Inventors: Masayuki KANEKO, Kariya-shi (JP); Hironari Nakagawa, Nagoya (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/971,703

(22) Filed: Jan. 9, 2008

(30) Foreign Application Priority Data
Jan. 10, 2007 (JP) 2007-002426

(51) Int. Cl. G01M 15/08; G01M 15/04

(52) U.S. Cl. 701/114; 701/115

(57) ABSTRACT

In a filtering apparatus, an analog filter filters a measured analog signal based on a predetermined filtering characteristic. An A/D converter converts, at constant time intervals, the filtered analog signal into a train of digital samples. A storage unit has a memory and stores, in the memory, the converted digital samples in the order from a first-converted digital sample in the train to a last-converted digital sample therein. A digital filtering unit has a second filtering characteristic substantially identical to the first filtering characteristic of the analog filter. The digital filtering unit reads out, from the memory, the digital samples in the order from the last-converted digital sample to the first-converted digital sample. The digital filtering unit filters the readout digital samples based on the second filtering characteristic in the order from the last-converted digital sample to the first-converted digital sample.

### CROSS REFERENCE TO RELATED APPLICATION

This application is based on Japanese Patent Application 2007-002426 filed on Jan. 10, 2007. This application aims at the benefit of priority from the Japanese Patent Application, so that the descriptions of which are all incorporated herein by reference.

### BACKGROUND OF THE INVENTION

1. Field of the Invention

The present invention relates to apparatuses for filtering measured analog signals associated with control of an engine installed in a vehicle.

2. Description of the Related Art

In engine control, cylinder pressure sensors, in other words, combustion pressure sensors, are installed in respective cylinders of an internal combustion engine. The cylinder pressure sensors work to measure individual pressures in the respective cylinders. Based on the measured individual pressures in the respective cylinders, proper ignition timings and air-fuel ratios (A/F ratios) for the respective cylinders are achieved. Such engine control using the pressures in respective cylinders are disclosed in US Patent Publication No. 5,738,074 corresponding to Japanese Unexamined Patent Publication No. H09-273437.

In particular, in a diesel engine, individual pressure signals indicative of pressures in respective cylinders measured by the corresponding cylinder pressure sensors are sent therefrom.

Based on the individual pressure signals, referred to CPS signals hereinafter, indicative of the pressures in the respective cylinders, combustion timings for the respective cylinders and combustion states are computed.

When such CPS signals are used to control engines, a noise suppression filer is required. In particular, the CPS signals contain noise components within a frequency band close to a predetermined frequency band to be used depending on the characteristics of the cylinder pressure sensors. For this reason, a certain high-order noise suppression filter is needed to reduce the noise components.

There are typical first and second methods for remove noise components from the CPS signals. The first method is to only use analog filter(s), and the second method is to use digital filters.

The second method requires analog filter(s). This is because an analog signal before sampling is required to be preprocessed using an analog anti-aliasing filter to remove aliasing noise therefrom.

In the second method, the number of orders of an analog filter can be reduced as compared with the first method, making it possible to reduce a CPS signal processor in size and cost. Specifically, setting the number of orders of a digital filter as high as possible allows setting of the number of orders of an analog filter (anti-aliasing filter) as low as possible. This reduction in the number of orders of the analog filter is however limited, and therefore, a certain high-order analog filter, such as a second-order analog filter, is required.

### SUMMARY OF THE INVENTION

In common analog and digital filters, the higher the number of orders, the greater the delay of an output signal in phase with respect to an input signal is. Because the CPS signals are used to compute combustion timings for respective cylinders set forth above, it is preferable that the delay of output signals in phase with respect to the CPS signals by filters is reduced as low as possible.

No proper methods for compensating the analog-filter delay of an output signal in phase with respect to an input signal are probably disclosed.

Note that, in digital filters, in order to carry out data analysis, a zero phase shift system is known. The zero phase shift system includes a digital filter, and a phase-delay compensating digital filter identical to the digital filter. More specifically, when a target train of input discrete samples is input to the digital filter, the target train of discrete samples is filtered by the digital filter to be output therefrom. The filtered target train of discrete samples is temporally stored in the zero phase shift system.

When the filtered target train of the discrete samples is used for the data analysis, the discrete samples of the target train stored in the system are read out therefrom in the order from the last sample to the first sample to be sequentially input to the phase-delay compensating digital filter. Thus, a compensated train of discrete samples is output from the phase-delay compensating digital filter; each of the discrete samples of the compensated train outputted from the phase-delay compensating digital filter is in phase with a corresponding one of the discrete samples of the target train.

In view of the background, an object of at least one aspect of the present invention is to provide apparatuses for filtering a measured signal associated with control of a vehicle engine; these apparatuses are capable of compensating a delay in an output signal from an analog filter with respect to the measured signal inputted to the analog filter.

According to one aspect of the present invention, an apparatus for filtering a measured analog signal associated with control of a vehicle engine is provided. The apparatus includes an analog filter into which the measured analog signal is input. The analog filter has a first predetermined filtering characteristic and works to filter the measured analog signal based on the predetermined filtering characteristic. The apparatus includes an analog-to-digital converter working to convert, at constant time intervals, the filtered analog signal into a train of digital samples. The apparatus includes a storage unit having a memory and working to store, in the memory, the converted digital samples in the order from a first-converted digital sample in the train to a last-converted digital sample therein. The apparatus includes a digital filtering unit having a second filtering characteristic substantially identical to the first filtering characteristic of the analog filter. The digital filtering unit works to: read out, from the memory, the digital samples in the order from the last-converted digital sample to the first-converted digital sample, filter the readout digital samples based on the second filtering characteristic in the order from the last-converted digital sample to the first-converted digital sample, and output the filtered digital samples as filtered data of the measured signal.

According to another aspect of the present invention, an apparatus for filtering a measured analog signal associated with control of a vehicle engine is provided. The apparatus includes an anti-aliasing filter into which the measured analog signal is input. The anti-aliasing filter has a predetermined first filtering characteristic and works to filter the measured analog signal based on the predetermined first filtering characteristic. The apparatus includes an analog-to-digital converter working to convert, at constant time intervals, the filtered analog signal into a train of digital samples. The apparatus includes a digital filter into which the digital samples of the train are sequentially input sample-by-sample. The digital filter has a predetermined second filtering characteristic and works to filter the digital samples based on the predetermined second filtering characteristic. The apparatus includes a storage unit having a memory and working to store, in the memory, the digital samples filtered by the digital filter in the order from a first-converted digital sample in the train to a last-converted digital sample therein. The apparatus includes a digital filtering unit provided with a first phase-delay compensating digital filter and a second phase-delay compensating digital filter. The first phase-delay compensating digital filter has a third filtering characteristic substantially identical to the first filtering characteristic of the anti-aliasing filter. The second phase-delay compensating digital filter has a fourth filtering characteristic substantially identical to the second filtering characteristic of the digital filter. The digital filtering unit works to: read out, from the memory, the digital samples in the order from the last-converted digital sample to the first-converted digital sample, first filter the readout digital samples by passing the digital samples through one of the first phase-delay compensating digital filter and the second phase-delay compensating digital filter in the order from the last-converted digital sample to the first-converted digital sample, second filter the first filtered digital samples by passing the first filtered digital samples through the other of the first phase-delay compensating digital filter and the second phase-delay compensating digital filter in the order from the last-converted digital sample to the first-converted digital sample, and output the second filtered digital samples as filtered data of the measured signal.

### BRIEF DESCRIPTION OF THE DRAWINGS

Other objects and aspects of the invention will become apparent from the following description of embodiments with reference to the accompanying drawings in which:

FIG. 1 is a view schematically illustrating an example of the structure of an engine electronic control unit (engine ECU) and a diesel engine according to an embodiment of the present invention;

FIG. 2 is a block diagram schematically illustrating an example of the structure of the engine ECU illustrated in FIG. 1;

FIG. 3 is a block diagram schematically illustrating an example of the structure of an analog filter illustrated in FIG. 2;

FIG. 4 is a flow chart schematically illustrating part of a design procedure of a second compensating filter illustrated in FIG. 2;

FIG. 5 is a flow chart schematically illustrating the remaining part of the design procedure of the second compensating filter illustrated in FIG. 2;

FIG. 6 is a timing chart schematically illustrating operation timings of a CPU and an ADC-DMA module illustrated in FIG. 2;

FIG. 7 is a flow chart schematically illustrating filtering operations of the CPU based on a first compensating filter and the second compensating filter illustrated in FIG. 2; and

FIG. 8 is a graph schematically illustrating the result of simulation of operations of the engine ECU when a sinusoidal wave on which a noise signal oscillating at 20 Hertz [Hz] is superimposed is input to the engine ECU as an input signal for the analog filter circuit illustrated in FIG. 2.

### DETAILED DESCRIPTION OF EMBODIMENTS OF THE INVENTION

An embodiment of the present invention will be described hereinafter with reference to the accompanying drawings.

In the embodiment, the present invention is applied to an engine electronic control unit (engine ECU) 1 installed in a vehicle for controlling, as a target device, a diesel engine 10 thereof. The diesel engine 10 is an example of various types of internal combustion engines.

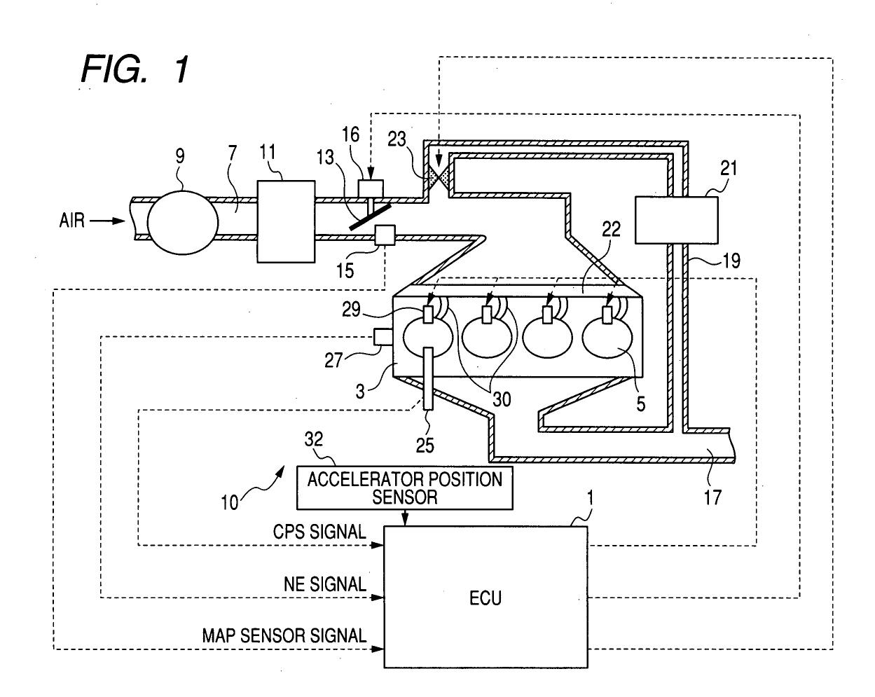

Referring to FIG. 1, the diesel engine 10 is equipped with, for example, four inner follow cylinders 5 each consisting of a combustion chamber. The combustion chamber of each cylinder 5 is formed with an intake port and an exhaust port (not shown).

The diesel engine 10 is equipped with an intake passage (intake manifold) 7 into which air can enter. The intake passage 7 is connected to the combustion chamber of each cylinder 5 via the intake port.

The diesel engine 10 is equipped with a compressor 9 of a turbocharger, an intercooler 11, a throttle valve 13, a motor 16, and a MAP (Manifold Absolute Pressure) sensor 15, which are disposed in the intake passage 7 from its upstream to its downstream.

When driven by, for example, a turbine of the turbocharger, the compressor 9 works to compress intake airflow entering it.

The intercooler 11 works to cool the compressed intake air, so the cooled intake air is transferred to the throttle valve 13.

The throttle valve 13 is rotatably disposed in the intake passage 7. The motor 16 serves as an actuator that works to rotatably drive the throttle valve 13.

Specifically, when energized, the motor 16 rotates the throttle valve 13 in the passage opening direction or the passage closing direction. This allows the opening of the intake passage 7 to be adjusted.

The adjustment of the opening of the intake passage 7 can control the amount of the intake air to be supplied to each of the combustion chambers of the cylinders 5.

The MAP sensor 15 works to measure the absolute pressure and the mass of the intake air flowing therethrough and to output the measured absolute pressure and mass of the intake air as a map sensor signal.

The diesel engine 10 is equipped with an intake valve (not shown) for each cylinder 5. The intake valve is disposed in the intake port and operative to open; this allows airflow through the intake passage 7 to be fed into the combustion chamber of each cylinder 5. In contrast, the intake valve is operative to close; this prevents airflow through the intake passage 5 from being fed into the combustion chamber of each cylinder 5.

The diesel engine 10 is equipped with a common rail 22 connected to the combustion chambers of the cylinders 5, and a number of, for example, four injectors 29 installed at its one distance ends in the respective combustion chambers of the cylinders 5.

The common rail 22 serves as an accumulator shared by the cylinders 5. Specifically, the common rail 22 is operative to accumulate fuel delivered from a fuel pump (not shown) therein with its pressure kept high.

The common rail 22 is also operative to uniformly feed the high-pressurized fuel accumulated therein to the individual injectors 29 via respective high-pressure fuel passages 30.

This allows each of the injectors 29 to directly meter the high-pressurized fuel into a corresponding one of the combustion chambers of the cylinders 5. This results that air contained in the combustion chamber of each of the cylinder 5 and the high-pressurized fuel metered thereinto are mixed to each other. The mixture of air and high-pressurized fuel in the combustion chamber of each cylinder 5 is subjected to combustion; this generates power to rotate a crankshaft of the diesel engine 10.

In addition, the diesel engine 10 is equipped with an exhaust passage 17 connected to the combustion chamber of each cylinder 5 via an exhaust valve (not shown). The exhaust valve is operative to open to permit a diesel exhaust gas ejected from the combustion chamber of each cylinder 5 to pass therethrough.

The diesel engine 10 is equipped with an EGR (Exhaust Gas Recirculation) passage 19, an EGR cooler 21, and an EGR valve 23.

The EGR passage 19 is communicably coupled to part of the intake passage 7 downstream of the throttle valve 13 and to part of the exhaust passage 17. The EGR passage 19 allows part of the exhaust gas from the exhaust passage 17 to be returned toward the intake passage 7 at the downstream of the throttle valve 13.

The EGR cooler 21 works to cool the returned exhaust gas.

The EGR valve 23 is disposed in the EGR passage 19 downstream of the EGR cooler 21.

The EGR valve 23 works to open or close; this allows the opening of the EGR passage 19 to be adjusted.

The adjustment of the opening of the EGR passage 19 can control the amount of exhaust gas to be recirculated from the exhaust passage 17 into the intake passage 7. In other words, the adjustment of the opening of the EGR passage 19 can control the amount of air to enter the intake passage 7.

Moreover, the diesel engine 10 is equipped with a number of, such as four, cylinder pressure sensors 25 respectively provided for the cylinders 5. In order to simplify the explanations of the engine 10, the cylinder pressure sensor 25 provided for one of the cylinders 5 is only illustrated in FIG. 1, but the remaining sensors 25 are similarly provided for the remaining cylinders 5, respectively.

For example, each of the cylinder pressure sensors 25 has a pressure-sensitive element installed in a corresponding one of the cylinders 5. The pressure-sensitive element works to generate, as a cylinder pressure sensor signal (CPS signal), an electric signal indicative of a pressure applied thereto as a pressure in the corresponding one of the cylinders 5.

Each of the cylinder pressure sensor 25 works to output and generate cylinder pressure signal (CPS signal).

The diesel engine 10 is also equipped with a crank angle sensor 27. For example, the crank angle sensor 27 includes a reluctor disc (signal rotor) having a plurality of teeth substantially spaced at angular intervals around the periphery of the disc. The reluctor disc is for example coaxially mounted on the crankshaft of the diesel engine 10 as the engine's main shaft for delivering rotary motion taken from reciprocating pistons and rods of the cylinders 5.

The crank angle sensor 27 for example includes a pickup operative to, for example, magnetically detect the teeth of the reluctor disc on the crankshaft as it rotates to generate a rotational signal, referred to as “NE signal” based on the detection result.

Specifically, the level of the NE signal changes in a predetermined same direction in a pulse every time the crankshaft (the reluctor disc) rotates at a unit angle of, for example, 10 degrees crank angle (CA). In the embodiment, for example, the predetermined same direction is set to a low-to-high direction.

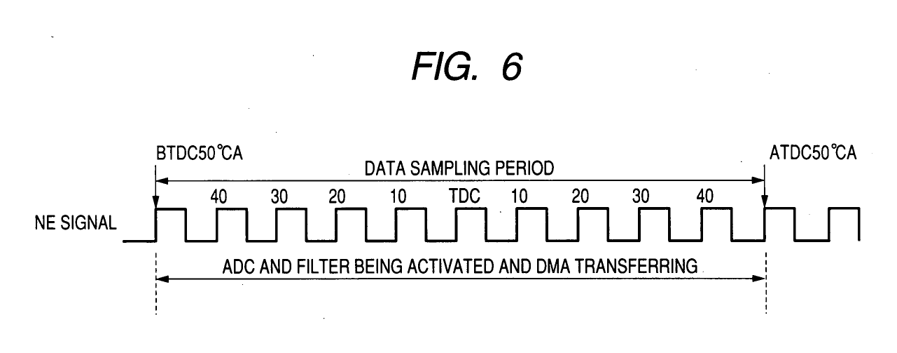

In other words, a significant edge, such as a rising edge, of the transient level change of the NE signal in a pulse appears every time the crankshaft rotates at the crank angle of 10 degrees (see FIG. 6).

The diesel engine 10 is further equipped with an accelerator position sensor 32. The accelerator position sensor 32 is disposed close to or attached to an accelerator pedal of the vehicle. The accelerator position sensor 32 works to detect an actual position and/or an actual stroke of the accelerator pedal depressed by the driver, and output, to the ECU 1, an electric signal indicative of the detected position and/or stroke of the accelerator pedal.

The ECU 1 is operative to:

receive the measurement signals outputted from the MPS sensor 15;, the cylinder pressure sensors 25, and the crank angle sensor 27; and

drive, based on the received measurement signals, each of the injectors 29, the EGR valve 23, and the motor 16, thus controlling a timing and a quantity of injection of each of the injectors 29, and the amount of exhaust gas to be recirculated from the exhaust passage 17 into the intake passage 7.

Particularly, the ECU 1 works to detect combustion timing of a cylinder 5 during its combustion cycle based on the received CPS signal outputted from the cylinder pressure sensor 25. Then, the ECU 1 works to control, based on the detected combustion timing, the drive of the EGR valve 23 and the drive of an injector 29 corresponding to a cylinder 5 during its combustion cycle.

The ECU 1 also works to drive the motor 16 to rotate the throttle valve 13 based on the received measurement signal indicative of the detected position and/or stroke of the accelerator pedal outputted from the accelerator position sensor 32 and the like, thus controlling the amount of air to be supplied into the combustion chambers therethrough.

Next, an example of part of the structure of the ECU 1 associated with the filtering task for the CPS signals will be described hereinafter.

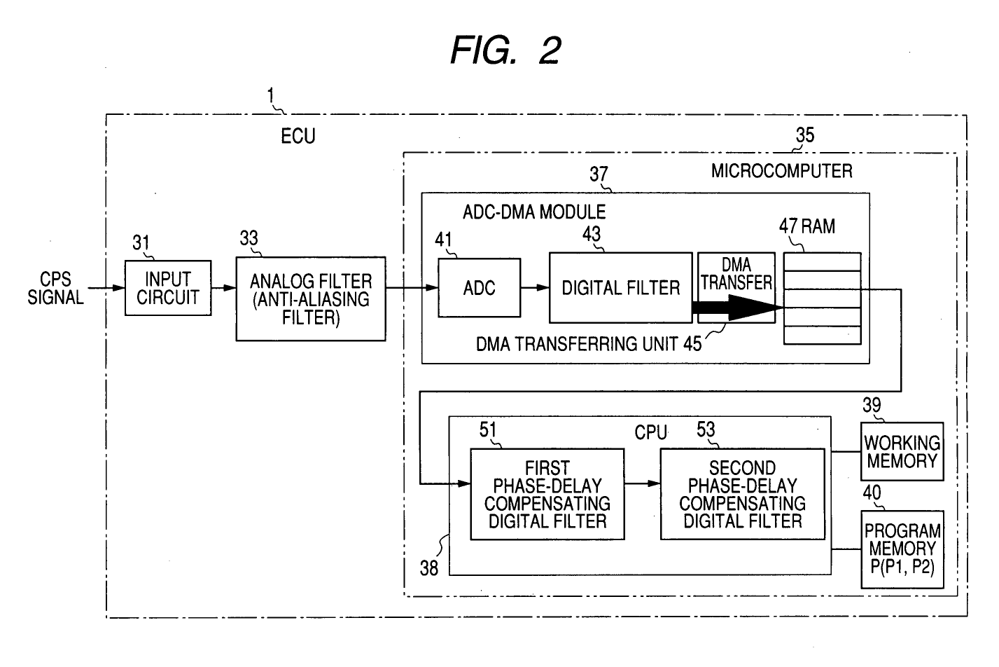

Referring to FIG. 2, the ECU 1 is provided with an input circuit 31 serving as an interface for inputting the CPS signal sent from each cylinder pressure sensor 25 into the ECU 1. The ECU 1 is also provided with an analog filter 33 into which the CPS signals captured by the input circuit 31 are input, and a microcomputer 35 into which the CPS signals passing through the analog filter 33 are input.

In the embodiment, for example, noise components whose frequencies resonant with the pressure-sensitive element of each of the cylinder pressure sensors 25 are easily superimposed on the CPS signal.

Thus, the microcomputer 35 has a function of:

sampling discrete values from each of the CPS signals at, for example, regular timings (sampling intervals) to convert each of the individual sampled values into a digital sample (a piece of CPS data); and

working to obtain digital samples that lie within a predetermined frequency range.

For this reason, in order to remove aliasing components from each of the CPS signals to be input to the microcomputer 35, the analog filter 31 functions as, for example, an anti-aliasing filter for removing aliasing noise from the CPS signals.

The microcomputer 35 consists of an ADC-DMA module (hardware module) 37, a CPU 38, a working memory, such as a RAM, 39, and a program memory, such as a ROM and/or EEPROM, 40; these components 37 to 40 are communicably linked to each other.

Various control programs P required to execute various tasks associated with control of the diesel engine 10 have been installed in the program memory 40. In the embodiment, the control programs P include a first digital-filter program module P1 for the analog filter 33 and a second digital-filter program module P2 for a digital filter 43 described hereinafter.

The ADC-DMA module 37 is capable of operating independently of the CPU's operations in accordance with the control programs P installed in the program memory 40.

The CPU 38 works to execute the various tasks based on the various control programs P.

The working memory 39 works to temporarily store data representing processing results of the CPU 35 and/or at least one of the programs P to be run.

The ADC-DMA module 37 is capable of operating independently of the CPU's operations in accordance with the programs P installed in the program memory 40.

Referring to FIG. 2, the ADC-DMA module 37 includes an analog-to-digital (A/D) converter (ADC) 41, a digital filter 43, a DMA (Direct Memory Access) transferring unit 45, and a RAM 47. The RAM 47 is connected to the CPU 38.

The A/D converter 41 has an input terminal connected to an output of the analog filter (anti-aliasing filter) 33, and an output terminal connected to an input terminal of the digital filter 43.

The A/D converter 41 is operative to sample discrete values from each of the CPS signals passing through the analog filter 33 at, for example, constant time intervals (sampling intervals) so as to convert each of the individual sampled values into a digital sample (a piece of CPS data). Each of the constant time intervals represents a period for sampling each of the CPS signals.

The A/D converter 41 is also operative to successively transfer the individually converted digital samples to the digital filter 43.

The digital filter 43 is designed as a high-order filter whose number of orders is determined as high as possible.

Specifically, the digital filter 43 works to:

receive the data sequence of the digital samples transferred from the A/D converter 41; and

obtain digital samples that lie within a predetermined frequency range from the received data; this predetermined frequency range depends on a plurality of predetermined filter coefficients.

The DMA transferring unit 45 is operative to successively transfer, to the RAM 47, the individual digital samples filtered by the digital filter 43 independently of the CPU 38.

The CPU 38 includes a first phase-delay compensating digital filter 51 and a second phase-delay compensating digital filter 53. Execution of the first digital-filter program module P1 allows the first phase-delay compensating digital filter 51 to be implemented, and execution of the second digital-filter program module P2 allows the second phase-delay compensating digital filter 53 to be implemented.

Specifically, the first digital-filter program module P1 causes the CPU 38 to carry out a filtering task of the first phase-delay compensating digital filter 51, and the second digital-filter program module P2 causes the CPU 38 to carry out a filtering task of the second phase-delay compensating digital filter 53. The first and second phase-delay compensating digital filter 51 and 53 will be referred to simply as “first and second compensating filters 51 and 53 hereinafter.

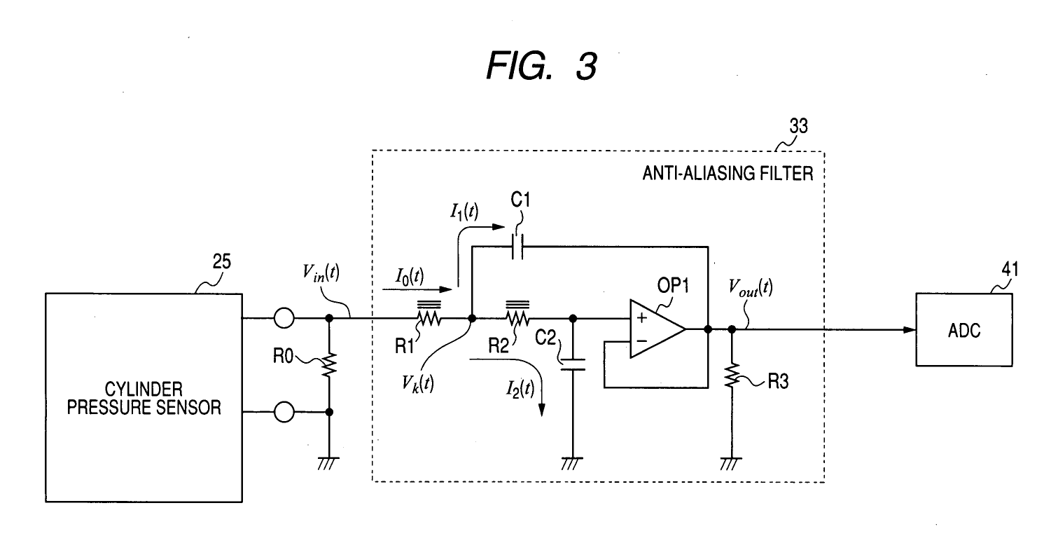

Next, an example of the structure of the analog filter (anti-aliasing filter) 33 will be described hereinafter with reference to FIG. 3.

The analog filter 33 is designed as a common second-order positive feedback low pass filter composed of, for example, a first resistor R1, a second resistor R2, a third resistor R3, a first capacitor C1, a second capacitor C2, and an operational amplifier OP1.

Specifically, the operational amplifier OP1 has a non-inverting input terminal, an inverting input terminal, and an output terminal. To the non-inverting input terminal, one end of the second resistor R2 is connected, the other end of which is connected to one end of the first resistor R1 so that the first and second resistors R1 and R2 are connected to the noninverting input terminal of the operational amplifier OP1 in series.

The first capacitor C1 is connected between a connecting point between the first and second resistors R1 and R2 and the output terminal of the operational amplifier OP1; this first capacitor C1 serves as a feedback capacitor. The second capacitor C2 is connected to a connecting point between the non-inverting terminal of the operational amplifier OP1 and the second resistor R2 and to a ground line. The third resistor R3 is connected to the output terminal of the operational amplifier OP1 and to the ground line.

A positive terminal of each of the cylinder pressure sensors 25 is connected to the other end of the first resistor R1. A negative terminal of each of the cylinder pressure sensors 25 is connected to the ground line. Reference character R0 represents a resistor disposed between the positive and negative terminals of each of the cylinder pressure sensors 25. The resistor R0 allows the CPS signal indicative of the pressure in a corresponding one of the cylinders 5 to be generated at the positive terminal of each of the cylinder pressure sensors 25.

When the CPS signal is input from the positive terminal of each of the cylinder pressure sensors 25 to the other end of the first resistor R1 of the analog filter 33, the CPS signal is filtered by the anti-aliasing filter 33 to be output to the A/D converter 41.

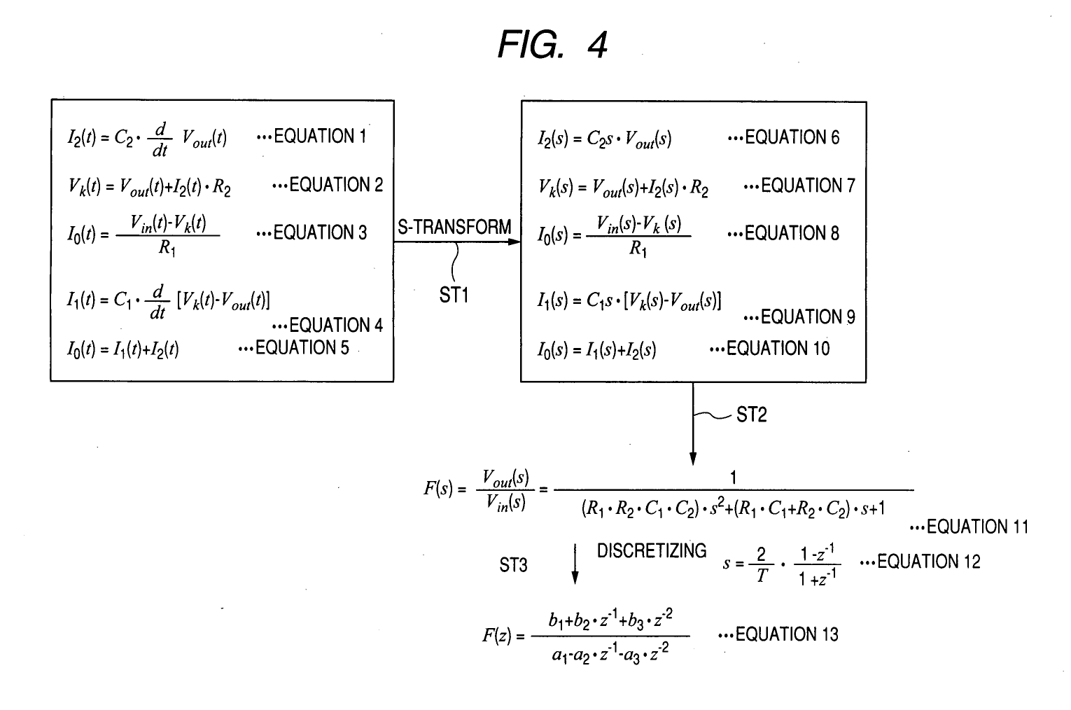

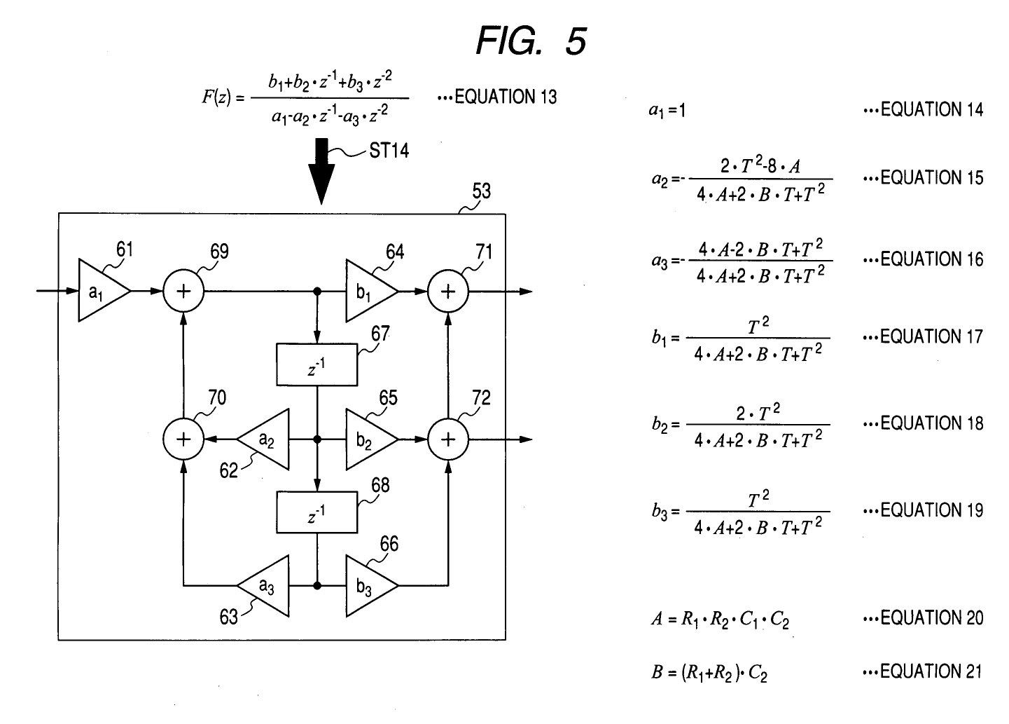

Next, the second compensating filter 53 equivalent to the analog filter 33 will be described with reference to FIGS. 4 and 5.

Specifically, the second compensating filter 53 is designed by discretizing the analog filter 33 such that a transfer function of the second compensating filter 53 is in agreement with that of the analog filter 33. Specifically, the second compensating filter 53 is designed by the following steps. The transfer function represents a filtering characteristic of each of the analog filter 33 and the second compensating filter 53.

Note that, in the following descriptions of the second compensating filter 53, R1 represents a resistance of the first resistor R1, R2 represents a resistance of the second resistor R2, C1 represents a capacitance of the first capacitor C1, C2 represents a capacitance of the second capacitor, and T represents the sampling intervals of the A/D converter 41.

As illustrated in FIG. 3, a voltage at the point between the other end of the first resistor R1 and the positive terminal of each of the cylinder pressure sensors 25 is represented by “Vᵢₙ(t)”, a voltage at the connecting point between the first and second resistors R1 and R2 is represented by “Vₖ(t)”, and a voltage at the output terminal of the operational amplifier OP1 is represented by Vₒᵤₜ(t). In addition, a current flowing through the first resistor R1 is represented by “₀(t)”, a current flowing through the first resistor R1 and through the first capacitor C1 is represented by “I₁(t)”, and a current flowing through the second resistor R2 and through the second capacitor C2 is represented by “I₂(t)”.

The voltages Vᵢₙ(t), Vₖ(t), Vₒᵤₜ(t) and currents I₀(1), I₁(t), I₂(t) respectively meet the corresponding following equations:

$$\begin{matrix}{I}_{2} ( t ) = {C}_{2} \cdot \frac{d}{d t} {V}_{out} ( t ) & [ Equation 1 ] \\ {V}_{k} ( t ) = {V}_{out} ( t ) + {I}_{2} ( t ) \cdot {R}_{2} & [ Equation 2 ] \\ {I}_{0} ( t ) = \frac{{V}_{i n} ( t ) - {V}_{k} ( t )}{{R}_{1}} & [ Equation 3 ] \\ {I}_{1} ( t ) = {C}_{1} \cdot \frac{d}{d t} [ {V}_{k} ( t ) - {V}_{out} ( t ) ] & [ Equation 4 ] \\ {I}_{0} ( t ) = {I}_{1} ( t ) + {I}_{2} ( t ) & [ Equation 5 ]\end{matrix}$$

Note that, in the equations [1] to [5], the reference character (t) assigned to each of the reference characters Vᵢₙ(t), Vₖ(t), Vₒᵤₜ(t), I₀(t), I₁(t), and I₂(t) represents that a corresponding voltage or current is in the time domain.

These equations [1] to [5] are Laplace transformed, that is, these equations [1] to [5] are transformed from the time domain into the s-domain (s-plane) in step ST1 of FIG. 4; this results that the following equations [6] to [10] are obtained:

$$\begin{matrix}{I}_{2} ( s ) = {C}_{2} s \cdot {V}_{out} ( s ) & [ Equation 6 ] \\ {V}_{k} ( s ) = {V}_{out} ( s ) + {I}_{2} ( s ) \cdot {R}_{2} & [ Equation 7 ] \\ {I}_{0} ( s ) = \frac{{V}_{i n} ( s ) - {V}_{k} ( s )}{{R}_{1}} & [ Equation 8 ] \\ {I}_{1} ( s ) = {C}_{1} s \cdot [ {V}_{k} ( s ) - {V}_{out} ( s ) ] & [ Equation 9 ] \\ {I}_{0} ( s ) = {I}_{1} ( s ) + {I}_{2} ( s ) & [ Equation 10 ]\end{matrix}$$

Note that, in the equations [6] to [10], the reference character (s) assigned to each of the reference characters Vᵢₙ(s), Vₖ(s), Vₒᵤₜ(s), I₀(s), I₁(s), and I₂(s) represents that a corresponding voltage or current is in the s-domain.

Based on the equations [6] to [10], the transfer function F(s) of the analog filter 33 in the s-domain is given by the following equation in step ST2:

$$\begin{matrix}F ( s ) = \frac{{V}_{out} ( s )}{{V}_{i n} ( s )} \\ = \frac{1}{( {R}_{1} \cdot {R}_{2} \cdot {C}_{1} \cdot {C}_{2} ) \cdot {s}^{2} + ( {R}_{1} \cdot {C}_{1} + {R}_{2} \cdot {C}_{2} ) \cdot s + 1}\end{matrix} \qquad [ Equation 11 ]$$

Next, the transfer function F(s) of the analog filter 33 in the s-domain expressed by the equation 11 is discretized in accordance with the following bilinear transform equation [12]; this results that a transfer function F(z) of the analog filter 33 in the z-domain (z-plane) is represented by the following equation [13] in step ST3:

$$\begin{matrix}s = \frac{2}{T} \cdot \frac{1 - {z}^{- 1}}{1 + {z}^{- 1}} & [ Equation 12 ] \\ F ( z ) = \frac{{b}_{1} + {b}_{2} \cdot {z}^{- 1} + {b}_{3} \cdot {z}^{- 2}}{{a}_{1} - {a}_{2} \cdot {z}^{- 1} - {a}_{3} \cdot {z}^{- 2}} & [ Equation 13 ]\end{matrix}$$

Reference characters a₁,a₂,a₃,b₁,b₂,b₃ of the equation [13] are constant values represented by the following equations [14] to [19];

$$\begin{matrix}{a}_{1} = 1 & [ Equation 14 ] \\ {a}_{2} = \frac{2 \cdot {T}^{2} - 8 \cdot A}{4 \cdot A + 2 \cdot B \cdot T + {T}^{2}} & [ Equation 15 ]\end{matrix}$$

where A and B are respectively given by the following equations [20] and [21]:

A=R₁·R₂·C₁·C₂ [Equation 20]

B=(R₁+R₂)·C₂ [Equation 21]

The second compensating filter 53 is therefore designed as an infinite impulse response filter (IIR filter) whose structure is illustrated in FIG. 5 such that a transfer function of the second compensating filter 53 in the z-domain is matched with the transfer function F(z) of the analog filter 33; this circuit structure of the second compensating filter 53 is composed of:

a multiplier 61 whose coefficient is a₁;

a multiplier 62 whose coefficient is a₂;

a multiplier 63 whose coefficient is a₃;

a multiplier 64 whose coefficient is b₁;

two delays 67 and 68; and

four adders 69, 70, 71, and 72

Specifically, an input of the multiplier 61 serves as an input terminal of the second compensating filter 53. An output of the multiplier 61 is connected to a first input of the adder 69, and that of the adder 70 is connected to a second input thereof. An output of the adder 69 is connected to an input of the multiplier 64 and to that of the delay 67. An output of the multiplier 64 is connected to a first input of the adder 71.

An output of the delay 67 is connected to an input of the multiplier 62, an input of the multiplier 65, and that of the delay 68. An output of the multiplier 62 is connected to a first input of the adder 70, and that of the multiplier 65 is connected to a first input of the adder 72. An output of the adder 72 is connected to a second input of the adder 71.

An output of the delay 68 is connected to an input of the multiplier 63, and that of the multiplier 66. An output of the multiplier 63 is connected to a second input of the adder 70, and that of the multiplier 66 is connected to a second input of the adder 72. An output of the adder 71 serves as an output terminal of the second compensating filter 53.

This circuit structure of the second compensating filter 53 meets the transfer function F(z) of the analog filter 33 in the z-domain.

As described above, the coefficients of the second compensating filter 53 can be obtained from the constant values of the transfer function F(z) of the analog filter 33 in the z-domain; this transfer function F(z) of the analog filter 33 in the z-domain can be obtained by:

transforming the equations representing currents and voltages at predetermined points of the analog filter 33 in the time domain into those in the s-domain to obtain the transformer function F(s); and

transforming the transformer function F(s) in the s-domain into the transformer function F(z) in the z-domain.

Similarly, the digital filter 43 has a transfer function H(z) in the z-domain, and the first compensating filter 51 has the same transfer function H(z) in the z-domain.

Next, operations to be executed by the microcomputer 35 in accordance with at least one of the programs P stored in the program memory 40 will be schematically described hereinafter.

In the following descriptions, the term “TDC (Top Dead Center)” represents a timing corresponding to a highest point of piston and rod travel in a cylinder 5 at the ends of the combustion exhaust strokes of the diesel engine 10.

The term “BTDC 50 degrees CA” represents a timing corresponding to a crank angle of the crankshaft before the TDC by 50 degrees CA, and ATDC 50 degrees CA represents a timing corresponding to a crank angle of the crankshaft after the TDC by 50 degrees CA.

FIG. 6 schematically illustrates a timing chart indicative of operation timings of the CPU 38 and the ADC-DMA module 37.

Referring to FIG. 6, the microcomputer 35 is programmed to detect combustion timing of a cylinder 5 based on the digital samples of the corresponding CPS signal filtered thereby. The digital samples have been obtained by the microcomputer 35 for the duration of the rotation of the crankshaft by 80 degrees CA from the timing of BTDC 40 degrees CA to the timing of ATDC 40 degrees CA.

In addition, the digital samples, which have been additionally obtained by the microcomputer 33 for the duration of the rotation of the crankshaft by 10° CA from the timing of BTDC 50 degrees CA to the timing of BTDC 40 degrees CA, are used to stabilize the result of filtering the CPS signal within the duration of the rotation of the crankshaft by 80 degrees CA.

Similarly, the digital samples, which have been additionally obtained by the microcomputer 33 for the duration of the rotation of the crankshaft by 10° CA from the timing of ATDC 40 degrees CA to the timing of ATDC 50 degrees CA, are used to stabilize the result of filtering the CPS signal within the duration of the rotation of the crankshaft by 80 degrees CA.

In particular, the additionally obtained digital samples corresponding to the duration of the rotation of the crankshaft by 10 degrees CA from the timing of ATDC 40 degrees CA to the timing of ATDC 50 degrees CA are provided in preparation for the filtering tasks (phase-delay compensating tasks) based on the first and second phase-delay compensating digital filters 51 and 53.

As set forth above, in the embodiment, a period of time during the rotation of the crankshaft by 100 degrees CA from the timing of BTDC 50 degrees CA to the timing of ATDC 50 degrees CA represents a time frame (data collecting period) for each of the CPS signals.

As illustrated in FIG. 6, every time each of the NE signal rises up (a rising edge appears), an NE signal interrupt occurs, at least one of the programs P corresponding to the NE signal interrupt is launched. This allows the CPU 35 to execute an NE interrupt task defined in the software programs P.

In particular, when a rising edge indicative of the timing of BTDC 50 degrees CA appears in each of the NE signals so that the data collecting period is started, a first NE signal interrupt occurs so that at least one of the software programs P corresponding to the first NE signal interrupt is activated.

The activation of the at least one of the software programs P causes the CPU 38 to activate the A/D converter 41, the digital filter 43, and the DMA transferring unit 45.

When a rising edge indicative of the timing of ATDC 50 degrees CA appears in each of the NE signals so that the data collecting period is terminated, a second NE signal interrupt occurs so that at least one of the software programs P corresponding to the second NE signal interrupt is activated.

The activation of the at least one of the software programs P causes the CPU 38 to deactivate the A/D converter 41, the digital filter 43, and the DMA transferring unit 45.

Within the period of time during the rotation of the crankshaft by 100 degrees CA from the timing of BTDC 50 degrees CA to the timing of ATDC 50 degrees CA, the CPS signal transferred through the analog filter 33 to be filtered thereby is sampled by the A/D converter 41. A target train of digital samples generated by the A/D converter 41 is input, sample-by-sample, to the digital filter 43 to be filtered thereby.

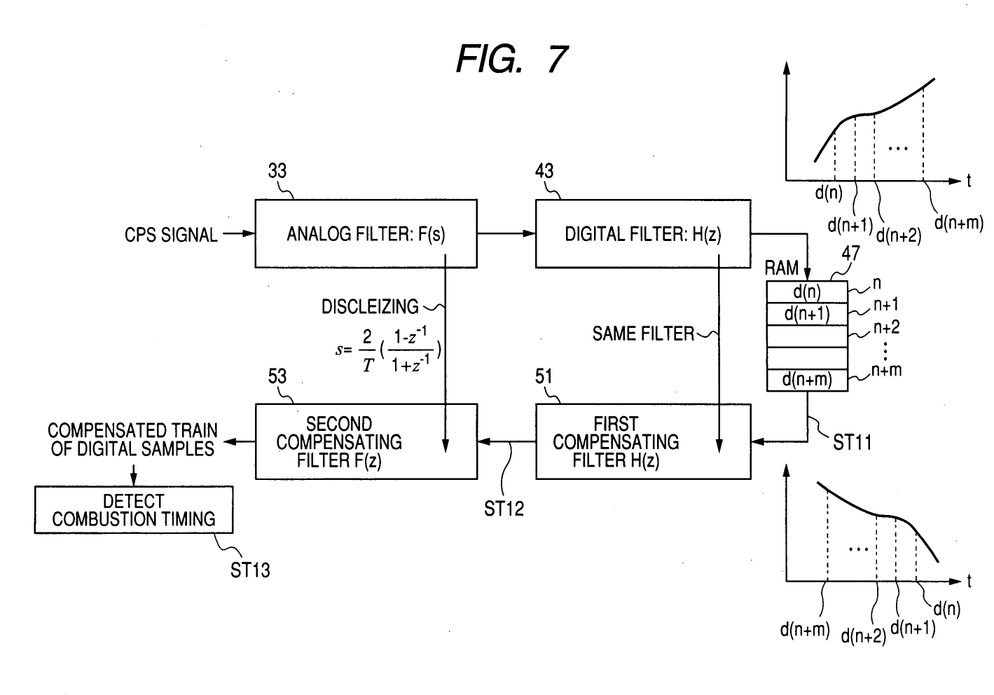

Thereafter, the target train of filtered digital samples outputted from the digital filter 43 is transferred, sample-by-sample, to the RAM 47 to be stored therein from a predetermined start address “n” to a predetermined end address “n+m” when the total number of the filtered digital samples is “m+1” (see FIG. 7).

Note that, as illustrated in FIG. 7, the first digital sample of the train of the digital samples stored in the first address “n” of the RAM 47 is represented by “d(n)”.

Similarly, the second digital sample, . . . , and the (m−1)th digital samples of the train of the digital samples stored in the second address “n+1”, . . . , and the (m−1)th address “n+m” of the RAM 47 are respectively represented by “d(n+1)”, . . . , “d(n+m)”.

After the target train of the digital samples “d(n)” to “d(n+m)” are completely stored in the corresponding addresses of the RAM 47, the CPU 38 is programmed to execute the following operations.

Specifically, the CPU 38 reads out the digital samples “d(n)” to “d(n+m)” of the target train from the RAM 47 in the order from the last sample “d(n+m)” stored in the (m−1)th address “n+m” to the first sample “d(n)” stored in the first address “n” of the RAM 47 in step ST11.

Then, the CPU 38 sequentially inputs, to the first compensating filter 51, the readout digital samples “d(n+m)” to “d(n)” of the target train so that the readout digital samples “d(n+m)” to “d(n)” of the target train are passed through the first compensating filter 51 in step ST11 of FIG. 7.

Specifically, the target train of the digital samples “d(n)” to “d(n+m)” are sequentially read out from the RAM 47 in the order from the last sample “d(n+m)” to the first sample “d(n)” so as to be sequentially filtered by the first compensating filter 51 whose transfer function H(z) is matched with that of the digital filter 43.

Next, the CPU 38 sequentially inputs, to the second compensating filter 53, the digital samples “d(n+m)” to “d(n)” of the target train filtered by the first compensating filter 51 so that the digital samples “d(n+m)” to “d(n)” of the target train are passed through the second compensating filter 53 in step ST12.

Specifically, the last sample “d(n+m)” to the first sample “d(n)” of the target train filtered by the first compensating filter 51 are further sequentially filtered by the second compensating filter 53 whose transfer function F(z) in the z-domain is matched with the transfer function F(s) of the analog filter 33 in the s-domain.

This results that a compensated train of digital samples is output from the second compensating filter 53; each of the digital samples of the compensated train outputted from the second compensating filter 53 is in phase with a corresponding one of the digital samples of the target train.

Thereafter, in step ST13, the CPU 38 of the ECU 1 or a CPU of another ECU works to:

reverse the order of the compensated train of digital samples arranged from the last sample “d(n+m)” to the first sample “d(n)” so as to obtain the compensated train of digital samples arranged from the first sample “d(n)” to the last sample “d(n+m)”; and

detect combustion timing of a cylinder 5 during its combustion cycle based on the compensated train of digital samples arranged from the first sample “d(n)” to the last sample “d(n+m)”.

As described above, in the ECU 1 according to the embodiment, even if the target train of digital samples outputted from the digital filter 43 is delayed in phase with respect to that inputted thereto, the first phase-delay compensating filter 51 allows the delay to be compensated.

In addition, even if the CPS signal outputted from the analog filter 33 is delayed in phase with respect to that inputted thereto, the second phase-delay compensating filter 53 allows the delay to be compensated.

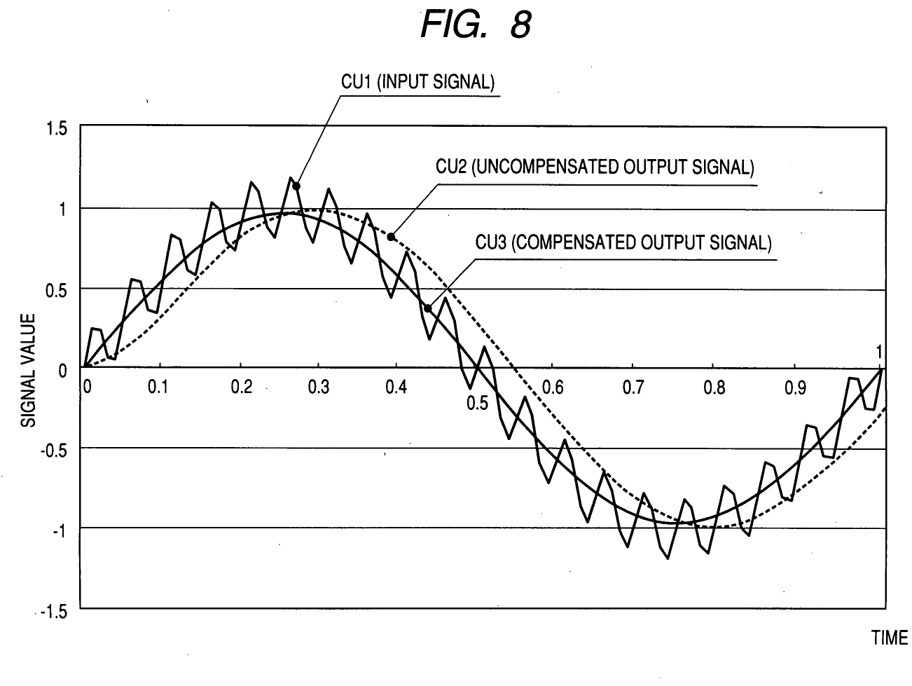

FIG. 8 schematically illustrates the result of simulation of operations of the engine ECU 1 when a sinusoidal wave on which a noise signal oscillating at 20 Hertz [Hz] is superimposed is input to the engine ECU 1 as an input signal for the analog filter circuit 33. In FIG. 8, the horizontal axis represents time, and the vertical axis thereof represents signal value normalized by 1.

In FIG. 8, reference character CU1 represents the waveform of the input signal. In addition, reference character CU2 represents an uncompensated output signal outputted from the digital filter 43 without being compensated in phase, and reference character CU3 represents a compensated output signal outputted from the second compensating filter 53 while being compensated in phase.

As illustrated in FIG. 8, the ECU 1 according to the first embodiment is configured such that the compensated output signal CU3 outputted from the second compensating filter 53 is in phase with the input signal CU1 as the CPS signal to be input to the ECU 1. This makes it possible to properly detect combustion timing of each of the cylinders 5 with little influence of the phase delay due to each of the analog filter 33 and the digital filter 43.

In addition, with the structure of the ECU 1 according to the embodiment, the phase delay due to the analog filter 33 is compensated by the software digital filter 53, making it possible to keep the size of the ECU 1 compact while maintaining the effect of proper detection of combustion timing of each of the cylinders 5.

With the structure of the ECU 1 according to the embodiment, the number of orders of the digital filter 43 can be set to be as high as possible; this makes it possible to reduce the number of orders of the analog filter (anti-aliasing filter) 33. Specifically, in the embodiment, the number of orders of the analog filter 33 can be set as low as possible, such as “2”. This can facilitate the reduction in size and/or manufacturing cost of the circuit structure of the ECU 1

In a first modification of the ECU 1 according to the embodiment, the digital filter 43 and the first compensating filter 51 can be omitted therefrom. In this first modification, the number of orders of the analog filter 33 can be increased as much as the ECU 1 is required. With the configuration of the ECU 1 according to the first modification, it is possible for only a pair of the analog filter 33 and the second compensating filter 53 to remove noise components from the CPS signal.

The order of the filtering task based on the first compensating filter 51 and that based on the second compensating filter 53 illustrated in FIGS. 2 and 7 can be reversed. Specifically, after completion of the filtering task based on the second compensating filter 53, that based on the first compensating filter 51 can be carried out.

Each of the first and second compensating filters 51 and 53 is implemented by software to be stored in a microcomputer, but the present invention is not limited to the structure. Specifically, in a second modification of the embodiment, each of the first and second compensating filters 51 and 53 can be implemented by at least one hardware circuit. Similarly, the digital filter 43 can be implemented by at least one hardware circuit.

A train of digital samples filtered by the digital filter 43 can be stored in the RAM 47 by the operations of the CPU 38 in accordance with at least one of the programs P.

The number of orders of the analog filter 33 can be changed to be greater than the second order.

In the embodiment, the present invention is applied to microcomputers installed in an engine ECU for processing a plurality of CPS signals each outputted from a corresponding one of cylinder pressure sensors. The present invention can be applied to data processors installed in an engine ECU or another ECU for processing a sensor signal input thereto; this sensor signal is required to control an engine of the vehicle.

While there has been described what is at present considered to be the embodiment and its modifications of the present invention, it will be understood that various modifications which are not described yet may be made therein, and it is intended to cover in the appended claims all such modifications as fall within the true spirit and scope of the invention.

What is claimed is:

1. An apparatus for filtering a measured analog signal associated with control of a vehicle engine, the apparatus comprising:
an analog filter into which the measured analog signal is input, the analog filter having a first predetermined filtering characteristic and working to filter the measured analog signal based on the predetermined filtering characteristic;
an analog-to-digital converter working to convert, at constant time intervals, the filtered analog signal into a train of digital samples;
a storage unit having a memory and working to store, in the memory, the converted digital samples in the order from a first-converted digital sample in the train to a last-converted digital sample therein; and
a digital filtering unit having a second filtering characteristic substantially identical to the first filtering characteristic of the analog filter and working to:
read out, from the memory, the digital samples in the order from the last-converted digital sample to the first-converted digital sample;
filter the readout digital samples based on the second filtering characteristic in the order from the last-converted digital sample to the first-converted digital sample; and
output the filtered digital samples as filtered data of the measured signal.

2. The apparatus according to claim 1, wherein the measured signal is a signal measured by a cylinder pressure sensor, the measured signal representing a pressure in a cylinder of the engine.

3. The apparatus according to claim 1, wherein the storage unit comprises:
a DMA (Direct Memory Access) transferring unit working to execute DMA transfer, sample-by-sample, of the train of the digital samples to the memory independently of the digital filtering unit.

4. An apparatus for filtering a measured analog signal associated with control of a vehicle engine, the apparatus comprising:
an anti-aliasing filter into which the measured analog signal is input, the anti-aliasing filter having a predetermined first filtering characteristic and working to filter the measured analog signal based on the predetermined first filtering characteristic;
an analog-to-digital converter working to convert, at constant time intervals, the filtered analog signal into a train of digital samples;
a digital filter into which the digital samples of the train are sequentially input sample-by-sample, the digital filter having a predetermined second filtering characteristic and working to filter the digital samples based on the predetermined second filtering characteristic;
a storage unit having a memory and working to store, in the memory, the digital samples filtered by the digital filter in the order from a first-converted digital sample in the train to a last-converted digital sample therein;
a digital filtering unit provided with a first phase-delay compensating digital filter and a second phase-delay compensating digital filter, the first phase-delay compensating digital filter having a third filtering characteristic substantially identical to the first filtering characteristic of the anti-aliasing filter, the second phase-delay compensating digital filter having a fourth filtering characteristic substantially identical to the second filtering characteristic of the digital filter, the digital filtering unit working to:
read out, from the memory, the digital samples in the order from the last-converted digital sample to the first-converted digital sample;
first filter the readout digital samples by passing the digital samples through one of the first phase-delay compensating digital filter and the second phase-delay compensating digital filter in the order from the last-converted digital sample to the first-converted digital sample;
second filter the first filtered digital samples by passing the first filtered digital samples through the other of the first phase-delay compensating digital filter and the second phase-delay compensating digital filter in the order from the last-converted digital sample to the first-converted digital sample; and
output the second filtered digital samples as filtered data of the measured signal.

5. The apparatus according to claim 4, wherein the measured signal is a signal measured by a cylinder pressure sensor, the measured signal representing a pressure in a cylinder of the engine.

6. The apparatus according to claim 4, wherein the storage unit comprises:
a DMA (Direct Memory Access) transferring unit working to execute DMA transfer, sample-by-sample, of the digital samples filtered by the digital filter to the memory independently of the digital filtering unit.

7. The apparatus according to claim 4, wherein the first filtering characteristic of the anti-aliasing filter includes a predetermined first transfer function, the third filtering characteristic of the first phase-delay compensating digital filter includes a second transfer function obtained by discretizing the predetermined first transfer function, the second filtering characteristic of the digital filter includes a predetermined third transfer function, and the fourth filtering characteristic includes substantially the same third transfer function.

8. The apparatus according to claim 7, wherein the anti-aliasing filer is a low pass filter composed of at least one resistor and at least one capacitor, the at least one resistor having a resistance, the at least one capacitor having a capacitance, and the first phase-delay compensating digital filter is an infinite impulse response filter composed of a plurality of multipliers, a plurality of delays, and a plurality of adders, the plurality of multipliers having coefficients, respectively, the coefficients of the plurality of multipliers being obtained from the resistance of the at least one resistor and the capacitance of the at least one capacitor.
